(19) United States
(12) Patent Application Publication
(10) Pub. No.: US 2006/0119615 A1
(43) Pub. Date: Jun. 8, 2006

(54) Usage mode for an electronic book

(75) Inventors: Guofu Zhou, Best (NL); Steven Broeils Luitjens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/560,716

(22) PCT Filed: Jun. 14, 2004
(86) PCT No.: PCT/IB04/50900

§ 371 Date: Dec. 15, 2005

Related U.S. Application Data
(60) Provisional application No. 60/479,214, filed on Jun. 17, 2003.

(51) Int. Cl. G09G 5/00

(52) U.S. Cl. 345/619

(57) ABSTRACT

A usage mode for an electronic reading device (300) such as an electronic book, such as those using electrophoretic displays, reduces delays in displaying a new page. Successive first and second pages are displayed on respective first and second display regions (410, 420; 610, 630, 650; 620, 640, 660). In response to a next page command provided after the user reads the first page, but before the user starts or completes reading the second page, a third page is displayed on the first display region in place of the first page, while the second page remains displayed on the second display region. In a first, initiation part of the command, first shaking pulses (710), which are not visible in the display region, are provided to the first display region to reduce image history effects. A second, display part of the command causes a drive pulse (740) to be provided to the first display region. A reset pulse (720) and further shaking pulses (730) may also be provided.

The invention relates generally to electronic reading devices such as electronic books and electronic newspapers and, more particularly, to a method and apparatus for displaying pages while minimizing delays.

Recent technological advances have provided “user friendly” electronic reading devices such as e-books that open up many opportunities. For example, electrophoretic displays hold much promise. Such displays have an intrinsic memory behavior and are able to hold an image for a relatively long time without power consumption. Power is consumed only when the display needs to be refreshed or updated with new information. So, the power consumption in such displays is very low, suitable for applications for portable e-reading devices like e-books and e-newspaper. Electrophoresis refers to movement of charged particles in an applied electric field. When electrophoresis occurs in a liquid, the particles move with a velocity determined primarily by the viscous drag experienced by the particles, their charge (either permanent or induced), the dielectric properties of the liquid, and the magnitude of the applied field.

For example, international patent application WO 99/53373, published Apr. 9, 1999, by E Ink Corporation, Cambridge, Mass., US, and entitled Full Color Reflective Display With Multichromatic Sub-Pixels, describes such a display device. WO 99/53373 discusses an electronic ink display having two substrates. One is transparent, and the other is provided with electrodes arranged in rows and columns. A display element or pixel is associated with an intersection of a row electrode and column electrode. The display element is coupled to the column electrode using a thin film transistor (TFT), the gate of which is coupled to the row electrode. This arrangement of display elements, TFT transistors, and row and column electrodes together forms an active matrix. Furthermore, the display element comprises a pixel electrode. A row driver selects a row of display elements, and a column driver supplies a data signal to the selected row of display elements via the column electrodes and the TFT transistors. The data signals correspond to graphic data to be displayed, such as text or figures.

The electronic ink is provided between the pixel electrode and a common electrode on the transparent substrate. The electronic ink comprises multiple microcapsules of about 10 to 50 microns in diameter. In one approach, each microcapsule has positively charged white particles and negatively charged black particles suspended in a liquid carrier medium or fluid. When a positive voltage is applied to the pixel electrode, the white particles move to a side of the microcapsule directed to the transparent substrate and a viewer will see a white display element. At the same time, the black particles move to the pixel electrode at the opposite side of the microcapsule where they are hidden from the viewer. By applying a negative voltage to the pixel electrode, the black particles move to the common electrode at the side of the microcapsule directed to the transparent substrate and the display element appears dark to the viewer. At the same time, the white particles move to the pixel electrode at the opposite side of the microcapsule where they are hidden from the viewer. When the voltage is removed, the display device remains in the acquired state and thus exhibits a bi-stable character. In another approach, particles are provided in a dyed liquid. For example, black particles may be provided in a white liquid, or white particles may be provided in a black liquid. Or, other colored particles may be provided in different colored liquids, e.g., white particles in green liquid.

Other fluids such as air may also be used in the medium in which the charged black and white particles move around in an electric field (e.g., Bridgestone SID2003—Symposium on Information Displays. May 18-23, 2003,—digest 20.3). Colored particles may also be used.

To form an electronic display, the electronic ink may be printed onto a sheet of plastic film that is laminated to a layer of circuitry. The circuitry forms a pattern of pixels that can then be controlled by a display driver. Since the microcapsules are suspended in a liquid carrier medium, they can be printed using existing screen-printing processes onto virtually any surface, including glass, plastic, fabric and even paper. Moreover, the use of flexible sheets allows the design of electronic reading devices that approximate the appearance of a conventional book.

However, one difficulty with such electronic reading devices is a relatively long image update time, especially for greyscale images/text update. Requirements for the associated driving waveform can further increase the update time. This can reduce the user's convenience when transitioning from one page to another in the electronic reading device, e.g., via a next page command or the like.

The present invention addresses the above and other issues.

In one aspect of the invention, an electronic reading device is provided for displaying successive first, second and third pages. The electronic reading device includes first and second display regions, and a control for controlling the first display region to display the first page thereon, and for controlling the second display region to display the second page thereon. A command for the third page may be given by the user well before finishing reading the second page. Preferably, the command for the third page is given directly after finishing reading the first page and well before completing the reading of the second page. In one approach, all processing for displaying the third page occurs right away in response to the command so that the third page can be displayed as soon as possible.

In another approach, the control is responsive to separate user commands for processing the third page in two stages. The user provides a first command, for example, after reading the first page but before starting to read the second page, or at least before completing the reading of the second page. In response to the first command, an initialization stage is triggered, which involves applying shaking pulses to the first display region. This initialization is not visible to the user, so the first page continues to be displayed in the first display region. The user provides a second command after reading the second page. In response to the second command, a display stage of the third page is triggered, which involves providing a drive pulse to the first display region. Optionally, a reset pulse, and further shaking pulses provided after the reset pulse but before the drive pulse, are also provided to the first display region. This results in the third page being displayed in the first display region. Since the initialization has previously occurred, the total time to display the third page is reduced.

In either case, all or a portion of the processing of the third page occurs without delaying the user's progress.

Related computer program products may also be provided.

In the drawings:

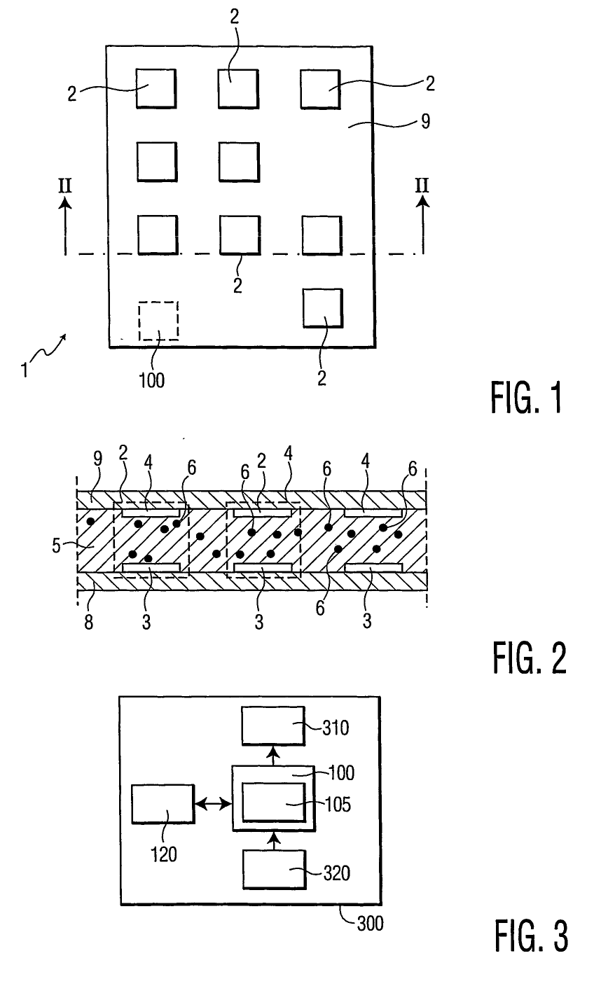

FIG. 1 shows diagramatically a front view of an embodiment of a portion of a display screen of an electronic reading device;

FIG. 2 shows diagramatically a cross-sectional view along II-II in FIG. 1;

FIG. 3 shows diagramatically an overview of an electronic reading device;

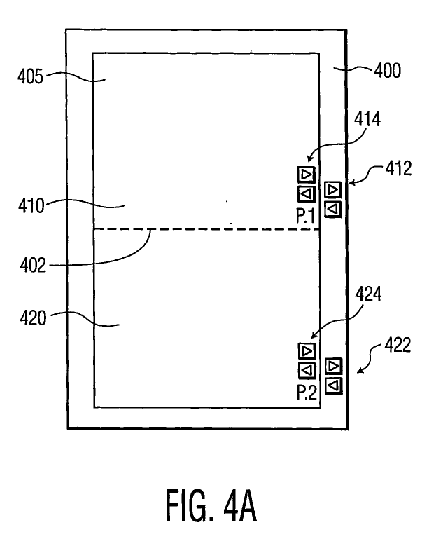

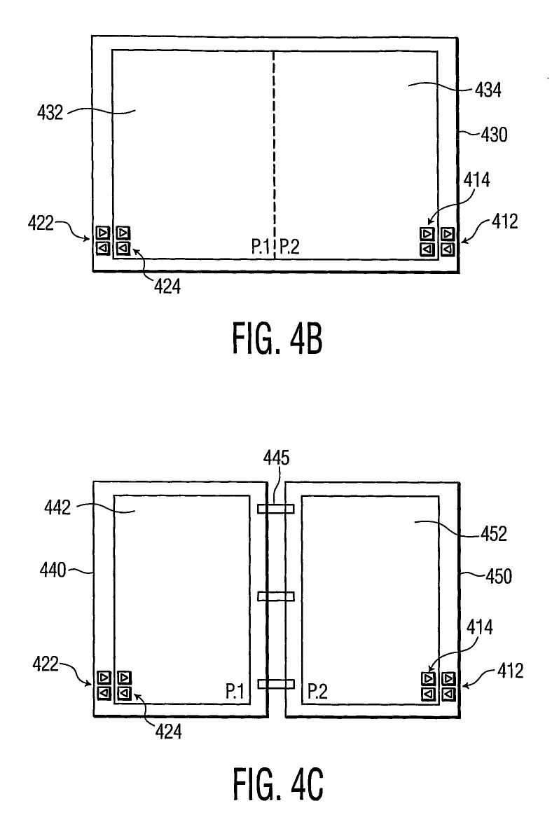

FIG. 4(a) shows diagramatically a display screen divided vertically into two display regions;

FIG. 4(b) shows diagramatically a display screen divided horizontally into two display regions;

FIG. 4(c) shows diagramatically two display screens with respective display regions;

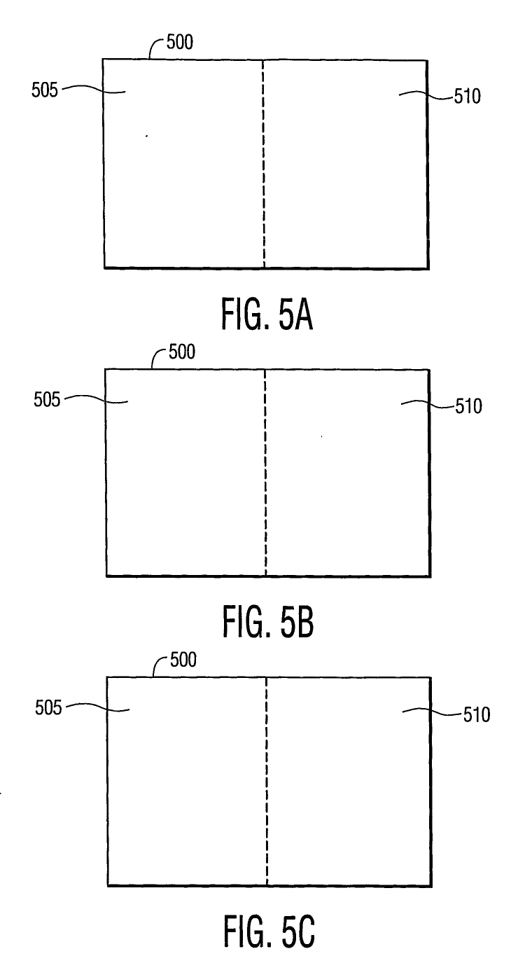

FIG. 5(a)-(c) show diagramatically a display of successive pages on a display screen divided horizontally into two display regions;

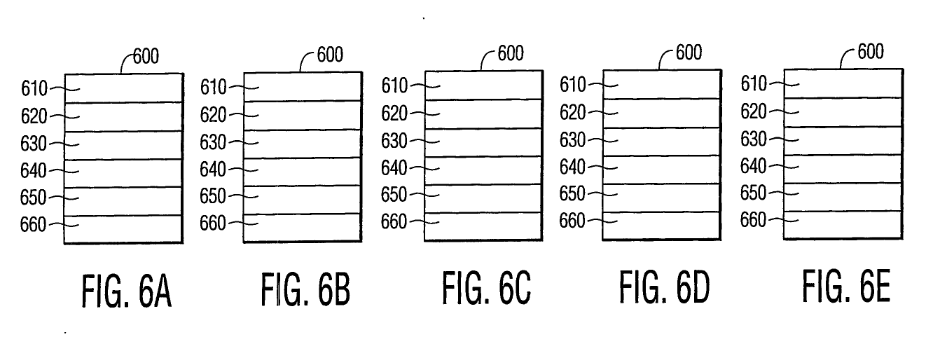

FIG. 6(a)-(c) show diagramatically a display of successive pages on a display screen with display regions formed by alternate display lines;

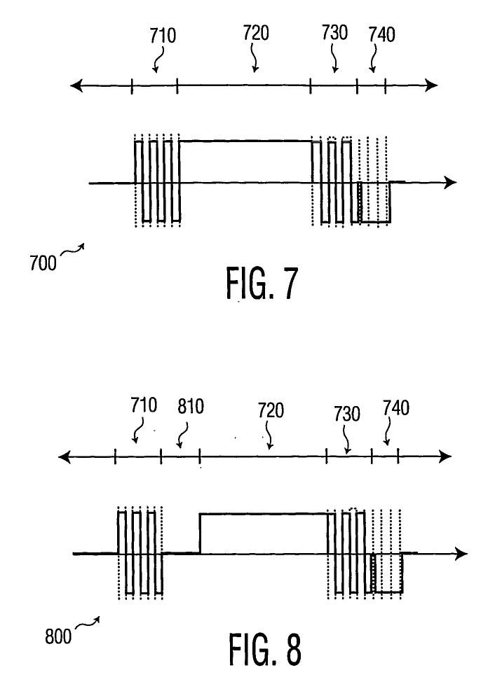

FIG. 7 shows diagramatically a first voltage waveform for driving a display screen of an electronic reading device; and

FIG. 8 shows diagramatically a second voltage waveform for driving a display screen of an electronic reading device.

In all the Figures, corresponding parts are referenced by the same reference numerals.

FIGS. 1 and 2 show the embodiment of a portion of a display panel 1 of an electronic reading device having a first substrate 8, a second opposed substrate 9 and a plurality of picture elements 2. The picture elements 2 may be arranged along substantially straight lines in a two-dimensional structure. The picture elements 2 are shown spaced apart from one another for clarity, but in practice, the picture elements 2 are very close to one another so as to form a continuous image. Moreover, only a portion of a full display screen is shown. Other arrangements of the picture elements are possible, such as a honeycomb arrangement. An electrophoretic medium 5 having charged particles 6 is present between the substrates 8 and 9. A first electrode 3 and second electrode 4 are associated with each picture element 2. The electrodes 3 and 4 are able to receive a potential difference. In FIG. 2, for each picture element 2, the first substrate has a first electrode 3 and the second substrate 9 has a second electrode 4. The charged particles 6 are able to occupy positions near either of the electrodes 3 and 4 or intermediate to them. Each picture element 2 has an appearance determined by the position of the charged particles 6 between the electrodes 3 and 4. Electrophoretic media 5 are known per se, e.g., from U.S. Pat. Nos. 5,961,804, 6,120,839, and 6,130,774 and can be obtained, for instance, from E Ink Corporation.

As an example, the electrophoretic medium 5 may contain negatively charged black particles 6 in a white fluid. When the charged particles 6 are near the first electrode 3 due to a potential difference of, e.g., +15 Volts, the appearance of the picture elements 2 is white. When the charged particles 6 are near the second electrode 4 due to a potential difference of opposite polarity, e.g., −15 Volts, the appearance of the picture elements 2 is black. When the charged particles 6 are between the electrodes 3 and 4, the picture element has an intermediate appearance such as a grey level between black and white. A drive control 100 controls the potential difference of each picture element 2 to create desired images or text in a full display screen. The full display screen is made up of numerous picture elements that correspond to pixels in a display.

FIG. 3 shows diagramatically an overview of an electronic reading device. The electronic reading device 300 includes the control 100, including an addressing circuit 105. The control 100 controls the one or more display screens 310, such as electrophoretic screens, to cause desired text or image to be displayed. For example, the control 100 may provide voltage waveforms to the different pixels in the display screen 310.

The addressing circuit provides information for addressing specific pixels, such as row and column, to cause the desired image or text to be displayed. The image or text data may be stored in a memory 120. One example is the Philips Electronics small form factor optical (SFFO) disk system. The control 100 may be responsive to a user-activated software or hardware button 320 which initiates a user command such as a next page command, previous page command. Optionally, the button 320 may be activated twice by the user for each page change. After a first activation, the next or previous page is initialized in a process that is not visible to the user. This may be done, for instance, prior to when the user nears the end of a page. The user may provide the second activation after completing the reading of the page to cause the next page to be displayed. Since the initialization has already occurred as a form of pre-processing, the time to display the next page after the second activation is reduced.

The control 100 may be part of a computer that executes any type of computer code devices, such as software, firmware, micro code or the like, to achieve the functionality described herein. Accordingly, a computer program product comprising such computer code devices may be provided in a manner apparent to those skilled in the art.

FIG. 4(a) shows diagramatically a display screen divided vertically into two display regions. The display screen 400 includes a first, top display region 410 that displays a first page, and second, bottom display region 420 that displays a second page. The display regions 410 and 420 may be provided on a common screen that is partitioned by a partition line 402 into the two regions. Various user interface devices may be provided to allow the user to initiate page forward, page backward commands and the like. For example, the first region may include on-screen buttons 414 that can be activated using a mouse or other pointing device, a touch activation or other known technique, to navigate among the pages of the electronic reading device. In addition to page forward and page backward commands, a capability may be provided to scroll up or down in the same page. Hardware buttons 412 may be provided alternatively, or additionally, to allow the user to provide page forward and page backward commands. The second region may also include on-screen buttons 424 and/or hardware buttons 422. Thus, each display region may be independently operated with its own buttons. Note that the frame 405 around the first and second display regions 410, 420 is not required as the display regions may be frameless.

In one possible design, the buttons 412, 414, 422, 424 are activated in a two-part process. The first activation may be made prior to when the user expects to complete the reading of a given page and transition to a next or previous page, while the second activation may be made when the user has completed the reading of the given page and desires to immediately view the next or previous page. The same button may be activated twice to this end. For example, the user may activate the buttons 412, 414 associated with the first region 410 on which the first page is displayed before continuing to read the second page on the lower part of the screen. This activation causes the initialization of the third page. Or, the user may activate the buttons 422, 424 associated with the second region when nearing the end of the second page or after completing the reading of the second page. It is also possible to provide a separate button for each activation, e.g., an “initialize” button and a “display” button, but this is believed to be less convenient. It is also possible to provide an indication to the user, such as an on-screen icon, or a light on the frame 405, regarding whether an initialization has occurred. Other interfaces, such as a voice command interface, may be used as well. Such an interface may respond to voice commands such as “ready next page” and “go to next page”, or “ready” and “go”, for example. Note that the buttons 412, 414; 422, 424 are not required for both display regions. That is, a single set of page forward and page backward buttons may be provided for the display screen 400. Or, a single button or other device, such as a rocker switch, may be actuated to provide both page forward and page backward commands.

FIG. 4(b) shows diagramatically a display screen divided horizontally into two display regions. The display screen 430 includes a first, left hand display region 432 that displays a first page, and second, right hand display region 434 that displays a second page. The display regions 432 and 434 may be provided on a common screen that is partitioned into the two regions. The first region 432 may include on-screen buttons 424 and/or hardware buttons 422, while the second region 434 may also include on-screen buttons 414 and/or hardware buttons 412.

FIG. 4(c) shows diagramatically two horizontally arranged display screens with respective display regions. Here, the display regions are provided on separate display screens. Specifically, a first display region 442 is provided on a first screen 440, and a second display region 452 is provided on a second screen 450. The first region 442 may include on-screen buttons 424 and/or hardware buttons 422, while the second region 452 may include on-screen buttons 414 and/or hardware buttons 412. The screens 440 and 450 may be connected by a binding 445 that allows the screens to be folded flat against each other, or opened up and laid flat on a surface. This arrangement is desirable since it closely replicates the experience of reading a conventional book.

FIG. 5(a) shows diagramatically a display screen divided horizontally into two display regions, with pages 1 and 2 displayed on respective first and second display regions. The page forward and page backward buttons are not shown but can be included as discussed previously. When reading a conventional book, two new pages are displayed each time a page is turned. However, electronic reading devices that follow this approach experience delays when displaying a new page. Accordingly, a new display order is presented that minimizes delays. This approach is generally applicable to all types of electronic reading devices such as e-books and e-newspapers, including those with bi-stable displays such as electrophoretic displays.

In one approach, a first page is displayed on a first display region 505 of a display screen 500, and a second page is displayed on a second display region 510 of the display screen 500. When a user has read the first and second pages and desires to read the next page, i.e., the third page, the user activates the next page button, either once or twice, to cause the third page to be displayed in the first display region 505 in place of the first page, while the second page remains displayed in the second display region 510, as shown in FIG. 5(b). When the user has read the third page and desires to read the next page, i.e., the fourth page, the user again activates the next page button, either once or twice, to cause the fourth page to be display in the second display region 510 in place of the second page, while the third page remains displayed in the first display region 505, as shown in FIG. 5(c). The first, second, third and fourth pages are successive pages in the electronic reading device. Note that the process can similarly be used for vertically arranged display regions as well.

In another approach, when the user has read the first page, the next page button is activated, either once or twice, to cause the third page to be initialized or displayed in the first display region 505 in place of the first page, after which a user starts reading the second page. When only the initialization process is activated, the first display region 505 is initialized using shaking pulses as discussed in connection with FIGS. 7 and 8 so that the third page is not yet visible, and the first page is still visible. When both the initialization and display processes are activated, the third page will become totally visible to the user. In this case, a complete waveform corresponding to the new information data of the third page is loaded and applied to the picture elements in the first display region 505 to cause the third page to be displayed as shown in FIG. 5(b). The choice of whether to provide only initialization, or both initialization and display, in response to a given user command, can be set depending on the choice of the user/interface design. When a user has read the second page, the next page button is activated, either once or twice, to cause the fourth page to be initialized or displayed in the second display region 510 in place of the second page, after which a user starts reading the third page. Again, the information of the fourth page can be made invisible when only the initialization process is activated, or made totally visible to the user when the whole waveform corresponding the new information data is loaded, depending on the choice of the user/interface design. It is preferable for the initialization processing to occur for a next page prior to when the user desires to read the next page. By performing the invisible initialization as a form of pre-processing of the next page, the time for displaying the next page is reduced when the user is ready to read the next page. This improves the convenience for the user.

The process can work in reverse for page back commands, e.g., as illustrated by the sequence FIG. 5(c), FIG. 5(b) and FIG. 5(a). Moreover, the process is equally applicable to languages in which text is read from right to left, such as Hebrew. In this case, the displays are a mirror image of the displays shown in FIGS. 5(a)-(c). For example, in FIG. 5(a), the first page would be on the right hand display region 510 and the second page would be on the left hand display region 505.

Additionally, note that the entire page need not be displayed on the respective display region. A portion of the page may be displayed and a scrolling capability provided to allow the user to scroll up, down, left or right to read other portions of the page. A magnification and reduction capability may be provided to allow the user to change the size of the text or images. This may be desirable for users with reduced vision, for example.

In any case, the approach of FIGS. 5(a)-(c) takes advantage of the fact that the pages are read one at a time and thus avoids the update time and loss of continuity that would be incurred by redisplaying two pages at a time. Moreover, even if there is some perceivable delay, e.g., in displaying the third page, the user continues to have the second page in front of him or her in the same display region so the user will not lose his or her position in the electronic reading device when the third page is displayed. Furthermore, by performing the initialization prior to when the next page is displayed, the information of the third page can be made completely visible for the user while the user is reading the second page, and the third page is ready to read directly after having read the second page. Thus, no waiting time is required for displaying the third page. The same holds for the fourth page, and so forth.

FIG. 6(a) shows diagramatically a display screen with alternate display lines of a first page. In this approach, text from different pages is displayed in different regions of a display screen 600 that comprise alternate groups of one or more lines of the display screen. For example, a first display region may include lines 610, 630, and 650 on which respective first, second and third lines of the first page are displayed. A second display region may include lines 620, 640, and 660, which are blank. Note that the approach described is equally applicable to languages such as Chinese in which text is read in lines of columns rather than rows. In this case, alternate columns are used instead of rows. Moreover, note that only three lines are shown for simplicity. In practice, many more lines may be used to simulate the appearance of a conventional book

When a user activates the first part of a two part next page command, e.g., the initialization part, alternate groups of one or more lines of the display screen are initialized for the next page, e.g., the second page. For example, the lines 620, 640, and 660 of the second display region are initialized while the lines in the first display region continue to display the first page, as shown in FIG. 6(b). Text is not visible in the lines 620, 640 and 660 during the initialization, so the lines. 610, 630 and 650 can continue to be read without distraction. As described further in connection with FIGS. 7 and 8, a voltage waveform comprising shaking pulses may be provided to the second display region during the initialization. The text of the second display region is not visible during the initialization so there is no confusion with text from different pages appearing at the same time. Preferably, the initialization of the second page is activated by the user before the user has started to read the first page, or at least prior to when the user has completed reading the first page. When the user activates the second part of the two part next page command, e.g., the display part, a voltage waveform is provided to the second display region to cause the alternate lines 620, 640 and 660 to display the second page, while a voltage waveform is provided to the first display region to blank out the display of the first page on the alternate lines 610, 630 and 650, as shown in FIG. 6(c).

Similarly, when the user again activates the first part of a two part next page command, the lines 610, 630, and 650 of the first display region are initialized while the lines 620, 640 and 660 in the second display region continue to display the second page, as shown in FIG. 6(d). When the user activates the second part of the two part next page command, a voltage waveform is provided to the first display region to cause the alternate lines 610, 630 and 650 to display the third page, while a voltage waveform is provided to the second display region to blank out the display of the second page on the alternate lines 620, 640 and 660, as shown in FIG. 6(e).

For any of the embodiments discussed herein, simple instructions can be provided to train the user to provide the two-part command as described to increase reading convenience. It is also possible for the control 100 to have logic that automatically provides the initialization of the next page. For example, referring to FIG. 6(a), the second page can be automatically initialized after the first page is displayed. Other logic can be used to initialize a next page after a predetermined amount of time. This logic can be adapted to a measured reading speed of the user based on the frequency at which the next page command is given.

FIG. 7 shows diagramatically a first voltage waveform for driving a display screen of an electronic reading device. As discussed in connection with FIG. 3, a controller 100 provides a signal such as a voltage waveform for controlling the appearance of each pixel in the display. Note that a separate waveform is provided for each pixel in the display. However, each waveform using for initialization may be the same. The example voltage waveform 700 has a level of zero prior to a time t1. Since an electrophoretic display exhibits a memory behavior, the previous optical state is retained even with no applied voltage. In the present example, it is assumed that the previous state is white. At a time t1, when the user initiates the initialization part of a two-part next page command, first shaking pulses 710 are provided to the pixels during an initialization phase that extends to time t2. The first shaking pulses 710 comprise at least one preset pulse with a pulse length of 20 msec or less, or even less than 10 msec., for example, and have a total duration up to approximately 100 to 160 msec., for example. The initialization pulses 710 include three positive and three negative preset pulses that are applied with a pulse length of 20 msec. and total duration of 120 msec. Generally, the first shaking pulses are short enough so that there is no visible change of the optic state of the display. Moreover, each shaking pulse has an energy, based on amplitude and duration, sufficient to release the electrophoretic particles from one of the extreme positions, e.g., black or white, but insufficient to enable the particles to reach the other extreme position, e.g., to transition from black to white, or from white to black. Moreover, the shaking pulses may alternate between the minimum and maximum voltages, e.g., −15V and +15V. The duration of the first shaking pulses is often approximately 20% of the duration of the waveform 700. Generally, this corresponds to the minimum reduction in the display time of a page.

At a time t2, the user initiates the display part of the two-part next page command. Note that the first shaking pulses 710 may be terminated after a predetermined amount of time if the user has not yet activated the second part of the next page command (see FIG. 8). At this time, a reset pulse 720 is provided to the pixels for a duration that is sufficient to move the particles to extreme optic states, e.g., black or white. This ensures that the old image is completely erased or blanked out during a new image update. The duration of the reset pulse 720 may take into account the previous optic state. For example, if it is known that the previous optic state is white, the duration of the reset pulse should be sufficient to drive the pixel to the black optic state. This duration depends on the electrophoretic properties of the medium being used. For example, a duration of up to 500 msec. may be used. In the present example, the pixel is driven to the black optic state at least by time t3.

At time t3, a second set of shaking pulses 730 may be provided to the pixel. Generally, these shaking pulses can have a similar pulse duration as the first shaking pulses 710. The total duration of the second shaking pulses 730 may be approximately one-half the duration of the first shaking pulses 710, e.g., (t4-t3)=½(t2-tl). The shaking pulses 710 and 730 have no visible optical effect but are important for achieving a high quality image and can be data independent. In particular, the shaking pulses 710 and 730 reduce the dwell time and image history effects, thereby reducing image retention and increasing greyscale accuracy. At time t4, a greyscale drive pulse is provided which causes the pixel to display a desired color, such as dark grey. The greyscale drive pulse has a level and duration in accordance with the optical state to be reached. It will be appreciated that both color and black and white images may be provided. As an example, the greyscale drive pulse may have a duration of 150 msec. At time t5, the drive waveform 700 returns to a zero value. The reset pulse 720, second shaking pulses 730 and drive pulse 740 may be considered to form the display portion of the waveform 700. Generally, in FIGS. 7 and 8, the first shaking pulses and drive pulses are needed to display the next page, while the reset pulse and second shaking pulses are optional.

Preferably, the entire sequence is initiated at time t1 in response to one next page command. This approach is desirable since the information of the third page, for instance, can be made completely visible for the user while the user is reading the second page, and the third page is ready to read directly after the user has completed reading the second page—thus no waiting time is required for displaying the third page. The same holds for the fourth page and so forth. This approach minimizes the update time in a situation where it is acceptable to have visible changes in the display screen portion that is being updated, such as shown in FIGS. 4 and 5. The waveform 700 is particularly suited to the display sequences of FIGS. 4(a)-(c) and 5(a)-(c), which have separate non-alternating display regions, because it is allowable to make the third page completely visible to the user on the first display region while the user is reading the second page on the second region of the screen.

FIG. 8 shows diagramatically a second voltage waveform for driving a display screen of an electronic reading device. This approach delays the display portion of the waveform until the user provides the second next page command. In particular, the voltage waveform 800 is similar to the waveform 700, but includes an inactive period 810 following the first shaking pulses 710. The reset pulse 720 begins at time t3 when the user initiates the display part of the two-part next page command. The waveform 800 is particularly suited to the alternate line display sequence of FIGS. 6(a)-(e) since it minimizes the update time while avoiding visible changes in the, e.g., odd, alternate lines of the display screen that are being updated that would be unacceptable until the user has completed reading the existing, e.g., even, alternate display lines. That is, it is not desirable to make the second page visible to the user on the second display region of the screen while the user is reading the first page on the first display region of the same screen on alternate lines. Only the portion of the waveform that does not result in a visible change on the display and that is independent of data to be displayed, i.e. the first shaking pulses, is loaded in the initialization process when the initialization command is activated.

The drawings of FIGS. 7 and 8 are not necessarily to scale. In FIG. 8, the inactive period 810 would likely be quite a bit longer than the initialization period, depending, e.g., on the reader's speed.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for displaying successive first, second and third pages of an electronic reading device, comprising:
displaying the first page on a first display region (505) of the electronic reading device (500);
displaying the second page on a second display region (510) of the electronic reading device; and
in response to a next page command, displaying the third page on the first display region (505) in place of the first page, while the second page remains displayed on the second display region (510).

2. The method of claim 1, further comprising:
in response to a further next page command, displaying a fourth page on the second display region (510) in place of the second page, while the third page remains displayed on the first display region (505).

3. The method of claim 1, wherein:
the first and second display regions comprise respective alternate display lines (610, 630, 650; 620, 640, 660) of a display screen.

4. The method of claim 1, wherein:
the first and second display regions comprise respective regions of a display screen.

5. The method of claim 1, wherein:
the first and second display regions comprise respective display screens.

6. The method of claim 1, wherein:
a user provides the next page command after reading the first page and prior to starting the reading of the second page.

7. The method of claim 1, wherein:
a user provides the next page command after reading the first page and prior to completing the reading of the second page.

8. An electronic reading device for displaying successive first, second and third pages, comprising:
first and second display regions (505; 510); and
a control (100) for controlling the first display region (505) to display the first page thereon, and for controlling the second display region (510) to display the second page thereon;
wherein, in response to a next page command, the control (100) controls the first display region to display the third page thereon in place of the first page.

9. A method for displaying successive first, second and third pages of an electronic reading device, comprising:
displaying the first page on a first display region (505) of the electronic reading device (300);
displaying the second page on a second display region (510) of the electronic reading device (300); and
in response to at least one user command, displaying the third page on the first display region (505) in place of the first page by providing voltage waveforms (700, 800) to the first display region (505), each voltage waveform including at least one shaking pulse (710) and a subsequent drive pulse (740).

10. The method of claim 9, wherein:
the at least one user command includes an initialization part and a display part;
the at least one shaking pulse (710) is provided in response to the initialization part; and
the drive pulse (740) is provided in response to the display part.

11. The method of claim 9, wherein:
a user provides the at least one user command after reading the first page and prior to starting the reading of the second page.

12. The method of claim 9, wherein:
a user provides the at least one user command after reading the first page and prior to completing the reading of the second page.

13. An electronic reading device for displaying successive first, second and third pages, comprising:
first and second display regions (505; 510); and
a control (100) for controlling the first display region (505) to display the first page thereon, and for controlling the second display region (510) to display the second page thereon;
wherein, in response to at least one user command, the control (100) controls the first display region to display the third page thereon in place of the first page by providing voltage waveforms (700, 800) to the first display region (505), each voltage waveform including at least one shaking pulse (710) and a subsequent drive pulse (740).

14. The electronic reading device of claim 13, wherein:
each voltage waveform (700, 800) includes a reset pulse (720) following the at least one shaking pulse (710) and preceding the drive pulse (740).

15. The electronic reading device of claim 14, herein:
each voltage waveform (700, 800) includes at least one further shaking pulse (730) following the reset pulse (720) and preceding the drive pulse (740).

16. The electronic reading device of claim 13, wherein:
an appearance of the first page on the first display region (505) is substantially unchanged when the at least one shaking pulse (710) is provided to the first display region.

17. The electronic reading device of claim 13, further comprising:
at least one of a hardware and software button (412, 414, 422, 424) to allow a user to provide the at least one command.

18. The electronic reading device of claim 13, wherein:
the first and second display regions comprise electrophoretic displays.

19. The electronic reading device of claim 13, wherein:
the at least one user command includes an initialization part and a display part;
the at least one shaking pulse (710) is provided in response to the initialization part; and
the drive pulse (740) is provided in response to the display part.

20. The electronic reading device of claim 19, wherein:
the initialization part and display part are each separately user-initiated.

21. A computer program product for displaying successive first, second and third pages of an electronic reading device, comprising:
computer code devices configured to cause a computer to:
display the first page on a first display region (505) of the electronic reading device (300);
display the second page on a second display region (510) of the electronic reading device; and
in response to a next page command, display the third page on the first display region (505) in place of the first page, while the second page remains displayed on the second display region (510).

22. A computer program product for displaying successive first, second and third pages of an electronic. reading device, comprising:
computer code devices configured to cause a computer to:
display the first page on a first display region (505) of the electronic reading device (300);
display the second page on a second display region (510) of the electronic reading device; and
in response to at least one user command, display the third page on the first display region (505) in place of the first page by providing voltage waveforms (700, 800) to the first display region, each voltage waveform including at least one shaking pulse (710) and a subsequent drive pulse (740).
